(19) United States
(12) Patent Application Publication
(10) Pub. No.: US 2014/0372737 A1
(43) Pub. Date: Dec. 18, 2014

(54) ELECTRONIC DEVICE AND METHOD FOR AUTOMATICALLY WAKING UP OPERATING SYSTEM OF ELECTRONIC DEVICE

(71) Applicants: Hon Hai Precision Industry Co., Ltd., New Taipei (TW); Hong Fu Jin Precision Industry (WuHan) Co., Ltd., Wuhan (CN)

(72) Inventors: MIN YANG, Shenzhen (CN); XIN-SHU WANG, Shenzhen (CN); JIAN-HUNG HUNG, New Taipei (TW)

(21) Appl. No.: 13/929,788

(22) Filed: Jun. 28, 2013

(30) Foreign Application Priority Data
Jun. 17, 2013 (CN) 2013102383812

(51) Int. Cl. G06F 9/44

(52) U.S. Cl. CPC G06F 9/4418
USPC 713/1

(57) ABSTRACT

In a method for waking up an operating system of an electronic device, a sensor of the electronic device is started and controlled to detect a distance between a specific object and the electronic device when a specific object enters into a detection area of the sensor. The detected distance is read from the sensor. The method determines whether the detected distance is more than a predefined distance and determines whether a current status of the electronic device is maintained for a first predefined time if the detected distance is not more than the predefined distance. An operating system of the electronic device is controlled to wake up when the predefined status of the electronic device is maintained for a first predefined time.

### BACKGROUND

1. Technical Field

The embodiments of the present disclosure relate to electronic devices, and more particularly to an electronic device and method for automatically waking up an operating system of the electronic device.

2. Description of Related Art

An operating system of an electronic devices, such as a server, an AIO (All In One) machine or a personal computer, usually be woke up from a sleep mode by a manual operation, which may be inconvenient.

### BRIEF DESCRIPTION OF THE DRAWINGS

FIG. 1 is a block diagram of one embodiment of an electronic device including a waking up system.

FIG. 2 is a block diagram of one embodiment of function modules of the waking up system in FIG. 1.

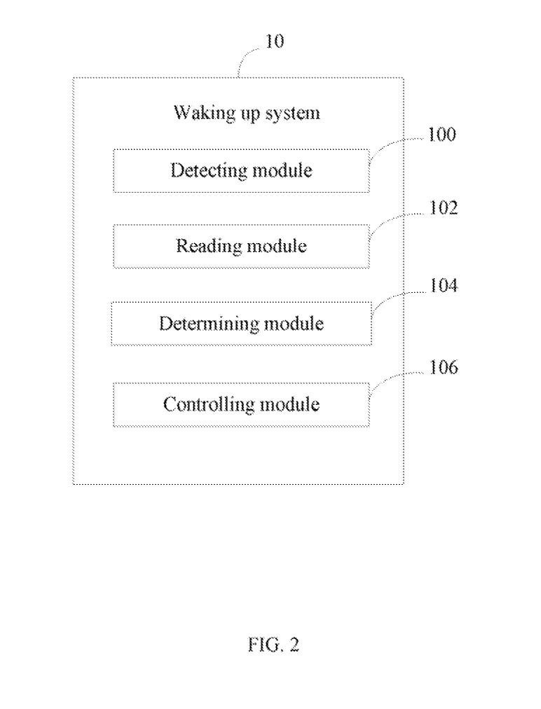

FIG. 3 is a flowchart of one embodiment of a method for automatically waking up an operating system the electronic device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

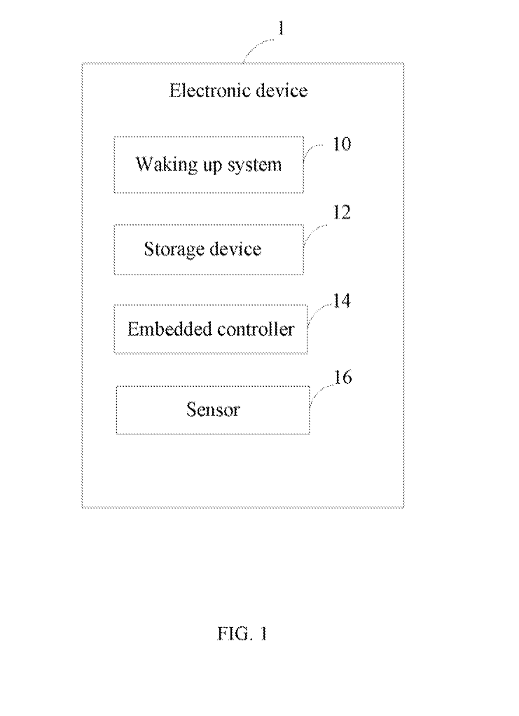

FIG. 1 is a block diagram of one embodiment of an electronic device 1 including a waking up system 10. The electronic device 1 comprises a storage device 12, at least one embedded controller 14, and a sensor 16. The electronic device 1 may be a PDA (personal digital assistant) device, an All In One (AIO) machine, a personal computer, or a tablet computer, for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one embedded controller 14 may include a processor unit, a microprocessor, an application-specific integrated circuit, and a field programmable gate array, for example.

The sensor 16 detects a distance between a specific object and the electronic device 1 when the specific object enters into a detection area (e.g., a range) of the sensor 16. In the embodiment, the specific object may be a human and other objects, and is located in front of the electronic device 1.

In one embodiment, the waking up system 10 includes a plurality of function modules which include computerized codes or instructions that can be stored in the storage device 12 and executed by the at least one embedded controller 14 to provide a method for waking up an operating system of the electronic device 1.

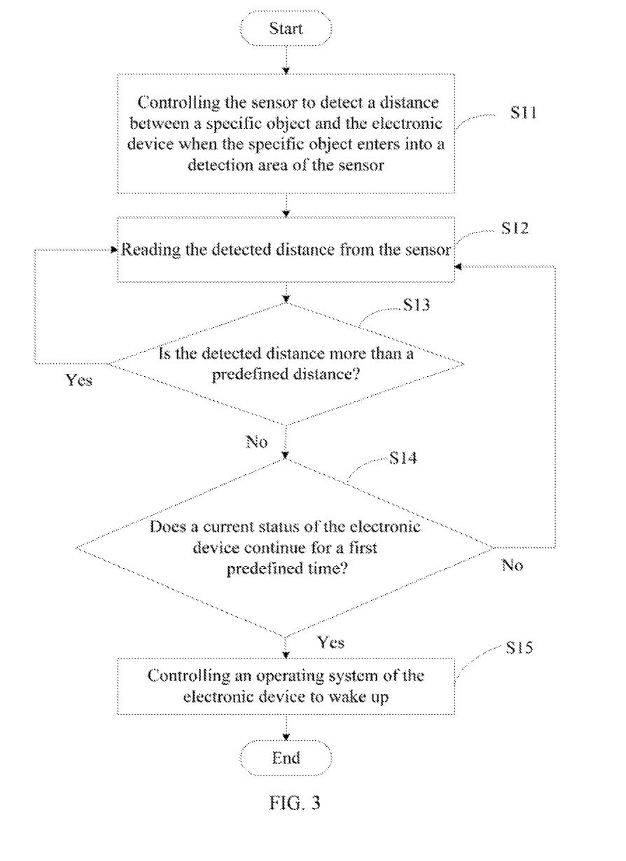

In one embodiment, the waking up system 10 may include a detecting module 100, a reading module 102, a determining module 104, and a controlling module 106. The modules may comprise computerized codes in the form of one or more programs that are stored in the storage device 12 and executed by the at least one processor 14 to provide functions for implementing the waking up system 10. The functions of the function modules are illustrated in FIG. 3 and described below.

FIG. 3 illustrates a flowchart of one embodiment of a method for automatically waking up an operating system of the electronic device 1. Depending on the embodiment, additional steps may be added, others removed, and the ordering of the steps may be changed.

In block S11, the detecting module 100 controls the sensor 16 to detect the distance between the specific object and the electronic device 1 when the specific object enters into the detection area of the sensor 16.

In block S12, the reading module 102 reads the detected distance from the sensor 16.

In block S13, the determining module 104 determines whether the detected distance is more than a predefined distance. If the detected distance is more than the predefined distance, S12 is repeated. If the detected distance is not more than (i.e., less than or equal to) the predefined distance, S14 is implemented. In the embodiment, the predefined distance is freely defined by a user of the electronic device 1 in a daily work of the electronic device 1. For example, the predefined distance may be defined as five meters or the like.

In block S14, the determining module 104 determines whether a current status of the electronic device 1 is maintained for a first predefined time (e.g., the status of the electronic device does not change) when the detected distance is not more than the predefined distance. If the current status of the electronic device 1 is maintained for the first predefined time, S15 is implemented. If the current status of the electronic device 1 is not maintained for the first predefined time, S12 is repeated. In the embodiment, the first predefined time may be freely defined by the user of the electronic device 1 in the daily work of the electronic device 1. For example, the predefined time may be defined as 30s or the like.

In block S15, the controlling module 106 controls the operating system of the electronic device 1 to wake up.

In some instances, after the operating system of the electronic device 1 is hibernated, the operating system of the electronic device 1 may be determined to be wrongly waken up. So, the sensor 16 may be defined to not start until a second predefined time after hibernating the operating system of the electronic device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one embedded controller; and
a storage device storing a computer program including instructions that, which executed by the at least one embedded controller, causes the at least one embedded controller to:
start a sensor of the electronic device, and control the sensor to detect a distance between a specific object and the electronic device when the specific object enters into a detection area of the sensor;
determine whether the detected distance is more than a predefined distance;
determine whether a current status of the electronic device is maintained for a first predefined time if the detected distance is not more than the predefined distance; and
control an operating system of the electronic device to wake up if the current status of the electronic device is maintained for the first predefined time.

2. The electronic device according to claim 1, wherein the predefined distance and the first predefined time are defined by a user of the electronic device in a daily work of the electronic device.

3. The electronic device according to claim 1, wherein the sensor is not started until a second predefined time after hibernating the operating system of the electronic device.

4. The electronic device according to claim 1, wherein the electronic device includes a waking up function which controls the sensor to detect the distance between the electronic device and the specific object.

5. The electronic device according to claim 1, wherein the sensor is maintained to detect the distance between the specific object and the electronic device if the detected distance is more than the predefined distance.

6. A method for automatically waking up an operating system of the electronic device, the method comprising:
starting a sensor of the electronic device, and controlling the sensor to detect a distance between a specific object and the electronic device when the specific object enters into a detection area of the sensor;
determining whether the detected distance is more than a predefined distance;
determine whether a current status of the electronic device is maintained for a first predefined time if the detected distance is not more than the predefined distance; and
controlling an operating system of the electronic device to wake up if the current status of the electronic device is maintained for the first predefined time.

7. The method according to claim 6, wherein the predefined distance and the first predefined time are defined by a user of the electronic device in a daily work of the electronic device.

8. The method according to claim 6, wherein the sensor is not started until a second predefined time after hibernating the operating system of the electronic device.

9. The method according to claim 6, wherein the electronic device includes a waking up function which is started to control the sensor to detect the distance between the electronic device and the specific object.

10. The method according to claim 6, wherein the sensor is maintained to detect the distance between the specific object and the electronic device if the detected distance is more than the predefined distance.

11. A non-transitory computer-readable storage medium having stored thereon instructions being executed by an embedded controller of an electronic device, causes the embedded controller to perform a method for automatically waking up an operating system of the electronic device, the method comprising:
starting a sensor of the electronic device, and controlling the sensor to detect a distance between a specific object and the electronic device when the specific object enters into a detection area of the sensor;
determining whether the detected distance is more than a predefined distance;
determine whether a current status of the electronic device is maintained for a first predefined time if the detected distance is not more than the predefined distance; and
controlling an operating system of the electronic device to wake up if the current status of the electronic device is maintained for the first predefined time.

12. The storage medium according to claim 11, wherein the predefined distance and the first predefined time are defined by a user of the electronic device in a daily work of the electronic device.

13. The storage medium according to claim 11, wherein the sensor is not started until a second predefined time after hibernating the operating system of the electronic device.

14. The storage medium according to claim 11, wherein the electronic device has a waking up function which is started to control the sensor to detect the distance between the electronic device and the specific object.

15. The storage medium according to claim 11, wherein the sensor is maintained to detect the distance between the specific object and the electronic device if the detected distance is more than the predefined distance.
